(19) United States
(12) Patent Application Publication
(10) Pub. No.: US 2026/0328660 A1
(43) Pub. Date: Oct. 22, 2026

(54) SPECIMEN MOUNT FOR SMALL CYLINDERS

(71) Applicant: University of Kentucky Research Foundation, Lexington, KY (US)

(72) Inventors: Martha E. Grady, Lexington, KY (US); Ella Tomko, Lexington, KY (US); William T. Anderson, Lexington, KY (US); Floyd Taylor, Lexington, KY (US)

(21) Appl. No.: 19/468,933

(22) Filed: Feb. 3, 2026

Related U.S. Application Data
(60) Provisional application No. 63/753,555, filed on Feb. 4, 2025.

(51) Int. Cl. G01N 1/36

(52) U.S. Cl. CPC G01N 1/36

(57) ABSTRACT

A specimen mount, adapted to hold an elongated specimen, includes a base and an upright clip projecting from the base. The upright clip includes a first prong and a second prong wherein margins of the first prong and the second prong define a notch adapted to receive and hold the elongated specimen. The specimen mount may be erected from an elongated, planar blank, having a base and a specimen support adapted to be erected so as to project from the base.

### RELATED APPLICATIONS

This application claims the benefit of U.S. Provisional Patent Application Ser. No. 63/753,555, filed Feb. 4, 2025, the disclosure of which is incorporated herein by reference in its entirety.

### GOVERNMENT SUPPORT

This invention was made with government support under Grant Nos. 2045853 and 2150337 awarded by the National Science Foundation (NSF). The government has certain rights in the invention.

### TECHNICAL FIELD

This document relates generally to a mount apparatus or specimen mount to hold cylindrical specimens with the long axis of the specimen horizontal.

### BACKGROUND

A number of different applications require a long, cylindrical workpiece to be held in place for processing. For example, dental implants need to be held in place to enable electron microscopy of the implant surface. The current state of the art for this purpose is a slotted holder or simply taping the cylinder to a platform. Disadvantageously, both of these approaches require significant contact between the cylinder and platform, potentially ruining the surface being processed.

This document relates to a workpiece or specimen mount adapted to hold small diameter, long cylinders in place during processing with very minimal touching. Long cylinders have a tendency to vibrate during electron microscopy making the images blurry. The new specimen mount holds the workpiece in place reducing vibration, which facilities higher resolution imaging. Additionally, minimal touching preserves the surface of interest for further testing after electron microscopy.

### SUMMARY

Each of the following terms written in singular grammatical form: “a”, “an”, and “the”, as used herein, means “at least one”, or “one or more”. Use of the phrase “One or more” herein does not alter this intended meaning of “a”, “an”, or “the”. Accordingly, the terms “a”, “an”, and “the”, as used herein, may also refer to, and encompass, a plurality of the stated entity or object, unless otherwise specifically defined or stated herein, or, unless the context clearly dictates otherwise. For example, the phrase: “a tab”, as used herein, may also refer to, and encompass, a plurality of tabs.

Each of the following terms: “includes”, “including”, “has”, “having”, “comprises”, and “comprising”, and, their linguistic/grammatical variants, derivatives, or/and conjugates, as used herein, means “including, but not limited to”, and is to be taken as specifying the stated component(s), feature(s), characteristic(s), parameter(s), integer(s), or step(s), and does not preclude addition of one or more additional component(s), feature(s), characteristic(s), parameter(s), integer(s), step(s), or groups thereof.

The phrase “consisting of”, as used herein, is closed-ended and excludes any element, step, or ingredient not specifically mentioned. The phrase “consisting essentially of”, as used herein, is a semi-closed term indicating that an item is limited to the components specified and those that do not materially affect the basic and novel characteristic(s) of what is specified.

Terms of approximation, such as the terms about, substantially, approximately, etc., as used herein, refers to ±10% of the stated numerical value.

In accordance with the purposes and benefits set forth herein, a specimen mount adapted to hold an elongated specimen, comprises, consists of or consists essentially of a base and an upright clip projecting from the base. The upright clip includes a first prong and a second prong. Margins of the first prong and the second prong define a notch adapted to receive and hold the elongated specimen.

In at least some embodiments, the specimen mount further includes a tab projecting from the base a distance from the upright clip whereby the tab and the upright clip provide two-point engagement with the elongated specimen.

The base may have a longitudinal axis and the tab and the upright clip may be located at spaced positions along the longitudinal axis.

In at least some embodiments, the specimen mount further includes a plurality of tabs. At least one tab of the plurality of tabs projects from the base a distance from the upright clip whereby the one tab and the upright clip provide two-point engagement with the elongated specimen.

In accordance with yet another aspect, a tool adapted to erect a specimen mount from a planar blank, comprises, consists of or consists essentially of: (a) a base, (b) a specimen support erector projecting from the base, (c) a cavity provided in the base and (d) a tab erector received in the cavity in the base. The tab erector projects from the base a distance from the specimen support erector whereby the tab and the specimen support erectors are adapted to erect a specimen support and a tab from the blank at desired, spaced positions for holding an elongated specimen.

In at least some of the many possible embodiments, the tab erector is adapted to be mounted at multiple positions within the cavity to allow for adjustment of the distance between the tab erector and the specimen support erector. This allows one to customize the specimen mount to better receive and hold the elongated specimen.

The base may have a longitudinal axis and the tab and the specimen support erectors may be located at spaced positions along the longitudinal axis. The cavity may have a length direction extending along the longitudinal axis of the base. The tool may also include cooperating guide posts that project from the base and are adapted to engage a guide track on the blank and guide the planar blank onto the tool, for proper erection into a specimen mount.

In accordance with still another aspect, an elongated, planar blank, comprises, consists of or consists essentially of a base and a specimen support adapted to be erected and project from the base.

In accordance with some embodiments, the elongated, planar blank further includes at least one tab adapted to be erected and project from the base. In some embodiments, the elongated, planar blank further includes a first hinge connecting a proximal end of the specimen support to the base. In some embodiments, the elongated, planar blank further includes a first cut line extending from a first end of the first hinge to a second end of the first hinge and defining an outline of the specimen support.

In some embodiments, the specimen support includes a first prong and a second prong wherein margins of the first prong and the second prong define a notch adapted to receive and hold the elongated specimen. In some embodiments, the elongated, planar blank further includes a second hinge connecting a proximal end of the tab to the base. In some embodiments, the elongated, planar blank further includes a second cut line extending from a first end of the second hinge to a second end of the second hinge and defining an outline of the tab. In some embodiments, the elongated, planar blank further includes a rounded relief cut at each end of the first cut line and the second cut line. In some embodiments, the elongated, planar blank includes a guide track adapted for guiding the blank onto a tool when erecting the blank into a specimen mount.

In accordance with yet another aspect, a method of supporting a specimen on a blank including a base, a specimen support and a tab, comprises, consists of or consists essentially of the steps of: (a) folding the specimen support about a first hinge into an upright position relative to the base, (b) folding the tab about a second hinge into an upright position relative to the base, and (c) positioning the specimen on the specimen support and the tab whereby the specimen is supported above the base.

Alternatively, a method of supporting a specimen on a blank including a base, a specimen support and a plurality of tabs, comprises, consists of or consists essentially of: (a) folding the specimen support about a first hinge into an upright position relative to the base, (b) selecting one tab from the plurality of tabs providing a desired distance between the specimen support and the one tab wherein that desired distance is adapted to hold the specimen for subsequent processing, (c) folding the one tab about a second hinge into an upright position relative to the base, and (d) positioning the specimen on the specimen support and the one tab whereby the specimen is supported above the base.

In the following description, there are shown and described several embodiments of the new and improved (a) specimen mount adapted to hold an elongated specimen, (b) tool adapted to erect a specimen mount from a planar blank, (c) elongated planar blank, and (d) method of supporting a specimen on a blank. As it should be realized, the specimen mount, tool, planar blank, and method are capable of other, different embodiments and their several details are capable of modification in various, obvious aspects all without departing from the formulations as set forth and described in the following claims. Accordingly, the drawing figures and descriptions should be regarded as illustrative in nature and not as restrictive.

### BRIEF DESCRIPTION OF THE DRAWING FIGURES

FIG. 1A is a perspective view of a first possible embodiment of the specimen mount;

FIG. 1B is a perspective view similar to FIG. 1A but the specimen mount is illustrated holding a specimen in the form of a screw portion of a dental implant.

FIG. 2 illustrates an elongated, planar blank, including a specimen clip and a single tab from which the specimen mount of FIGS. 1A and 1B may be erected.

FIG. 3 illustrates a second possible embodiment of an elongated, planar blank, including a specimen clip and a plurality of tabs from which a specimen mount may be erected.

FIG. 4 illustrates a third possible embodiment of an elongated, planar blank, including a specimen clip and a single tab from which a specimen mount may be erected.

FIG. 5 is a perspective view of a first tool used to erect the blank of FIG. 2 into the specimen mount shown in FIG. 1 with the specimen clip and a single tab brought to a 90 degree angle from their original prone blank position.

FIG. 6 is a perspective view of a second tool used to erect the blank of any of FIGS. 2-4 into a specimen mount having the specimen clip and a single tab brought to a 45 degree angle from their original prone blank position.

### DETAILED DESCRIPTION

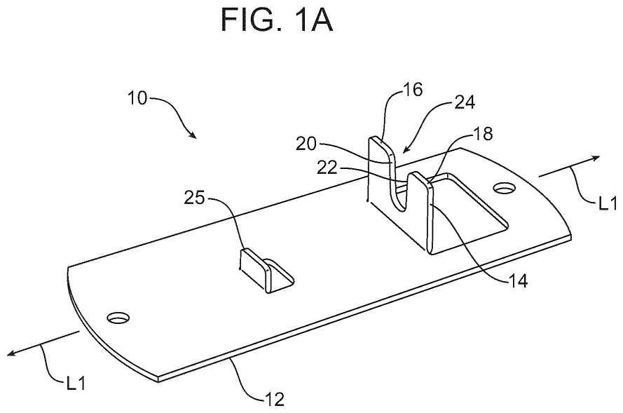

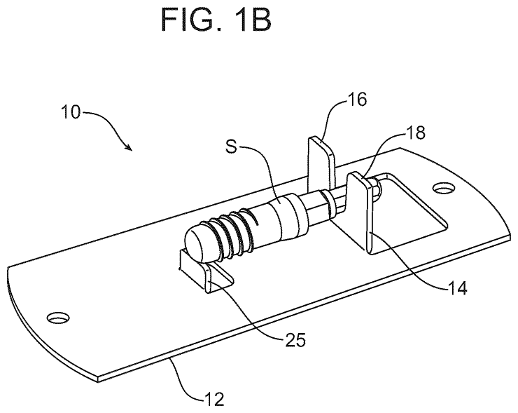

Reference is now made to FIGS. 1A and 1B illustrating a first possible embodiment of the new and improved specimen mount 10. Unlike existing mounts, which are typically optimized for flat or irregular samples, this mount 10 advantageously addresses the unique challenge of stabilizing small cylindrical objects with minimal contact points, ensuring accurate imaging without introducing artifacts. This innovation provides significant advantages, including improved specimen stability during imaging, enhanced reproducibility of results, and compatibility with a range of cylinder sizes (1-10 mm diameter and 6-30 mm length). These benefits are particularly valuable for quality control and failure analysis in industries like dental implant manufacturing, where precise surface characterization is critical.

As illustrated, the specimen mount 10 includes an elongated base 12, having a longitudinal axis L1. A specimen support 14, in the form of an upright clip, projects upwardly from the base 12. In the illustrated embodiment, the upright clip 14 includes a first prong 16 and a second prong 18. The respective margins 20, 22 of the first prong 16 and the second prong 18 define a notch, generally designated by reference numeral 24, that is adapted to receive and hold one end of the elongated specimen S. An upright tab 25 supports the other end of the elongated specimen S. The elongated specimen S shown in FIG. 1B is a dental implant.

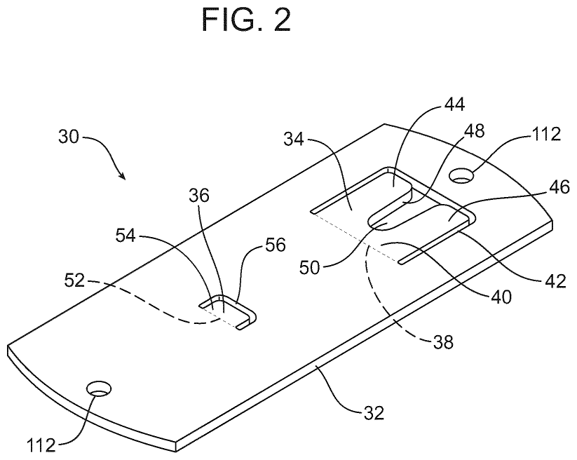

Reference is now made to FIG. 2 which illustrates one possible embodiment of an elongated planar blank 30 from which a specimen mount, such as the one illustrated in FIGS. 1A and 1B, may be erected. The blank 30 includes a base 32 and a specimen support 34 adapted to be erected and project from the base 32. Still further, the blank 30 includes a tab 36 adapted to be erected and project from the base 12. A first hinge 38 connects a proximal end 40 of the specimen support 34 to the base 32. A first cut line 42 extends from a first end of the first hinge 38 to a second end of the first hinge and defines an outline of the specimen support 34.

In the illustrated embodiment, the specimen support 34 comprises a first prong 44 and a second prong 46 wherein margins 48 of the first prong and the second prong define a notch 50 adapted to receive and hold the elongated specimen when the specimen support is folded upward about the first hinge 38 into an upwardly projecting position in a manner similar to that shown in FIGS. 1A and 1B.

The elongated, planar blank 30 also includes a second hinge 52 connecting a proximal end 54 of the tab 36 to the base 32. A second cut line 56 extends from a first end of the second hinge 52 to a second end of the second hinge and defines an outline of the tab 36.

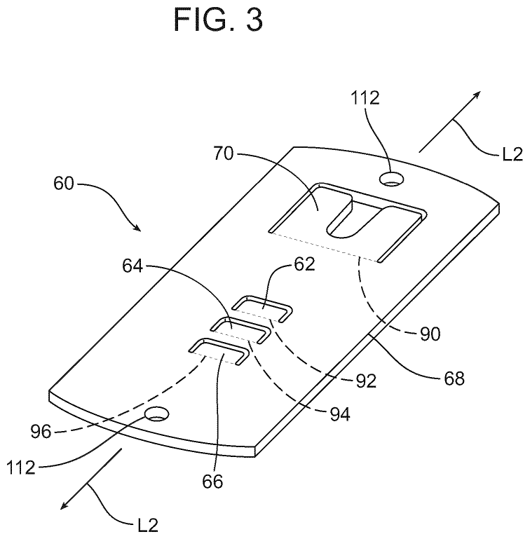

FIG. 3, illustrates another possible embodiment of an elongated, planar blank 60, that is similar to the elongated, planar blank 30 illustrated in FIG. 2, except that it includes multiple tabs, 62, 64 and 66. One may select and erect the tab 62, 64 or 66 a desired distance along the longitudinal axis L2 of the base 68 from the specimen support 70 as needed to better support and hold a specimen (not shown). Thus, for example, for a relatively short specimen, one may erect the tab 62, which is closest to the specimen support 70. In contrast, for a relatively long specimen, one may select to erect the tab 66 that is furthest from the specimen support 70. If the specimen is of intermediate length, one may select to erect the tab 64 that is an intermediate distance from the specimen support 70. For some applications to hold some specimens, it may be desirable to erect more than one of the tabs 62, 64, 66.

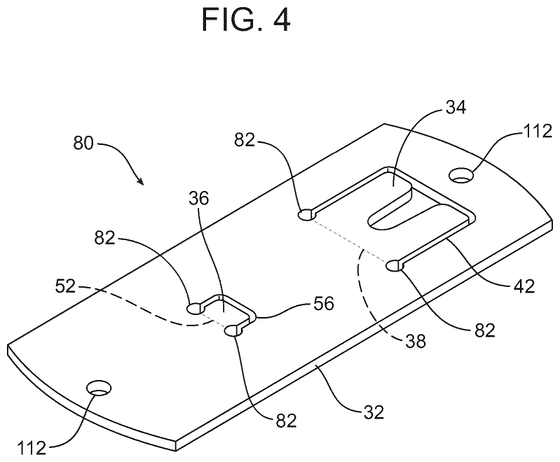

FIG. 4 illustrates yet another possible embodiment of the elongated, planar blank 80 similar to that shown in FIG. 2. Corresponding structure of the two embodiments 30, 80 are identified by identical reference numbers. This embodiment of the blank 80 differs from the blank 30 by the presence of rounded relief cuts 82 at each end of the first cut line 42 and the second cut line 56 which is also at the ends of the first hinge 38 and the second hinge 52. These relief cuts 82 are resistant to tearing and will help maintain the structural integrity of the base 32 when the integral hinges 38, 52 are folded to erect the specimen support 34 and the tab 36.

The elongated, planar blanks 30, 80 of FIGS. 2 and 4, disclosed above, are useful in a method of supporting a specimen on a blank including a base 32, a specimen support 34 and a tab 36. That method may be broadly described as including steps of:

folding the specimen support 34 about a first hinge 38 into an upright position relative to the base 32;

folding the tab 36 about a second hinge 52 into an upright position relative to the base; and

positioning the specimen on the specimen support and the tab whereby the specimen is supported above the base.

The elongated, planar blank 60 of FIG. 3, disclosed above is useful in a method of supporting a specimen on a blank including a base 68, a specimen support 70 and a plurality of tabs 62, 64, 66, including the steps of:
folding the specimen support about a first hinge 90 into an upright position relative to the base;
selecting at least one tab 62, 64 or 66 from the plurality of tabs providing a desired distance between the specimen support and the one tab wherein that desired distance is adapted to hold the specimen for subsequent processing;
folding the at least one tab about a second hinge 92, 94 or 96 into an upright position relative to the base; and
positioning the specimen on the specimen support and the at least one folded tab whereby the specimen is supported above the base.

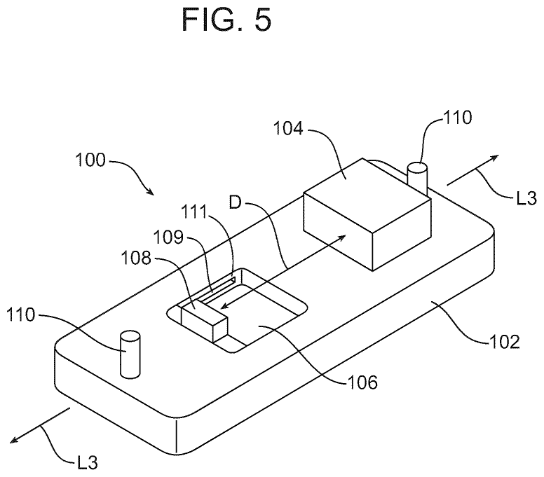

Reference is now made to FIG. 5, which illustrates a first tool 100 used to erect the blank of FIG. 2 into the specimen mount shown in FIGS. 1A and 1B with the specimen clip 14 and a single tab 25 brought to a 90 degree angle from their original prone blank position. The tool 100 includes an elongated base 102, having a longitudinal axis L3. A specimen support erector 104, in the form of an upright block, projects upwardly from the base 102. The specimen mount 100 also includes a cavity 106 and a tab erector 108. The specimen support erector 104 and the cavity 106 are located at spaced positions along the longitudinal axis L3.

The tab erector 108 is received and held in the cavity 106 in the base 102. The tab erector 108 projects from the base a distance D from the specimen support erector 104. By adjusting the lateral position of the tab erector 108 within the cavity 106, it is possible to adjust the distance D between the specimen support erector 104 and the tab erector 108. Toward this end, the lateral ends of the tab erector 108 may include projecting tabs (not visible) that slide in elongated slots 109 in the opposed sidewalls 111 of the cavity 106.

As further illustrated in FIG. 5, the tool 100 also includes two guide posts 110: one adjacent each end of the tool. The blank 30 to be erected by the tool 100 includes a guide track 112 in the form of two cooperating apertures. When a blank 30, such as illustrated in FIG. 2, is placed on the tool 100 for erection, the guide track apertures 112 are aligned with and received over the cooperating guide posts 110 to align the specimen support 34 and the tab 36 of the blank 30 with the respective specimen support erector 104 and the tab erector 108. The blank 30 is then pressed down over the tool 100 so that (a) the specimen support erector 104 erects the specimen support at an angle of 90 degrees with respect to the base 32 and (b) the tab erector 108 erects the tab 36 at an angle of 90 degrees with respect to the base 32, thereby erecting the specimen mount 10 illustrated in FIGS. 1A and 1B.

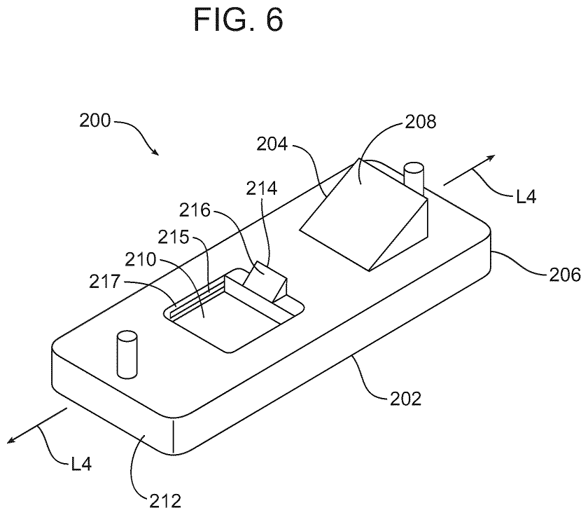

Reference is now made to FIG. 6 which illustrates yet another possible embodiment of a tool 200 used to erect a specimen mount from a blank in the manner described above with reference to FIG. 5. The tool 200 includes an elongated base 202 having a longitudinal axis L4. A specimen support erector 204, in the form of a wedge, is provided adjacent one end 206 of the base 202. Note the sloping face 208. A cavity 210 is provided toward the opposite end 212. The specimen support erector 204 and the cavity 210 are located at spaced positions along the longitudinal axis L4.

A tab erector 214 is held in any of various positions in the cavity 210 along the longitudinal axis L4. By adjusting the lateral position of the tab erector 214 within the cavity 210, it is possible to adjust the distance D between the specimen support erector 204 and the tab erector 214, to better accommodate and hold specimens of different sizes/lengths. Toward this end, the lateral ends of the tab erector 214 may include projecting tabs (not visible) that slide in elongated slots 215 in the opposed sidewalls 217 of the cavity 210. As shown, the tab erector 214 may also take the form of a wedge shape, if desired. Note the sloping face 216. The sloped faces 208 and 216 of the specimen support erector 204 and the tab erector 214 erect the specimen support 70 and the tab 62, 64 or 66 of the blank 60 at an angle of 45 degrees relative to the base 68. The tool 200 also includes two guide posts 220 for aligning a blank 60 on the tool by cooperative engagement with the guide tracks 112 in the blank in the manner described above.

In the illustrated embodiment of FIG. 6, the specimen support erector 204 and the tab erector 214 include sloping faces 208, 216 that slope in the same direction. In other embodiments, the sloping faces 208, 216 of the specimen support erector 204 and tab erector 214 may slope in different directions. The faces 208, 216 may slope at the same or at different angles relative to the base 202.

Any of the embodiments of the specimen mount and planar blanks 10, 30, 60, 80 illustrated in FIGS. 1A, 1B, 2, 3 and 4 may be made, for example, by water jet cutting, laser cutting, computer controlled machining, wire electrical discharge machining and other means such as 3D printing. The specimen mounts and planar blanks 10, 30, 60, 80 may be made from plastic, composite, metal or any appropriate material.

Although the specimen mount and related method of this disclosure have been illustratively described and presented by way of specific exemplary embodiments, and examples thereof, it is evident that many alternatives, modifications, or/and variations, thereof, will be apparent to those skilled in the art. Accordingly, it is intended that all such alternatives, modifications, or/and variations, fall within the spirit of, and are encompassed by, the broad scope of the appended claims.

What is claimed:

1. A specimen mount adapted to hold an elongated specimen, comprising:
a base; and
an upright clip projecting from the base, the upright clip including a first prong and a second prong wherein margins of the first prong and the second prong define a notch adapted to receive and hold the elongated specimen.

2. The specimen mount of claim 1, further including a tab projecting from the base a distance from the upright clip whereby the tab and the upright clip provide two-point engagement with the elongated specimen.

3. The specimen mount of claim 2, wherein the base has a longitudinal axis and the tab and the upright clip are located at spaced positions along the longitudinal axis.

4. The specimen mount of claim 1, further including a plurality of tabs, wherein at least one tab of the plurality of tabs projects from the base a distance from the upright clip whereby the one tab and the upright clip provide two-point engagement with the elongated specimen.

5. The specimen mount of claim 4, wherein the base has a longitudinal axis and the plurality of tabs and the upright clip are located at spaced positions along the longitudinal axis.

6. A tool adapted to erect a specimen mount from a planar blank, comprising:
a base;
a specimen support erector projecting from the base;
a cavity provided in the base;
a tab erector received in the cavity in the base, wherein the tab erector projects from the base a distance from the specimen support erector.

7. The tool of claim 6, wherein the tab erector is adapted to be mounted at multiple positions within the cavity to allow for adjustment of a distance between the tab erector and the specimen support erector.

8. The tool of claim 6, wherein the base has a longitudinal axis and the tab erector and the specimen support erector are located at spaced positions along the longitudinal axis.

9. The tool of claim 8, wherein the cavity has a length direction extending along the longitudinal axis of the base.

10. The tool of any of claim 6, further including cooperating guide posts projecting from the base and adapted to guide the planar blank on the tool.

11. An elongated, planar blank, comprising a base and a specimen support adapted to be erected and project from the base.

12. The elongated, planar blank of claim 11, further including at least one tab adapted to be erected and project from the base.

13. The elongated, planar blank of claim 12, further including a first hinge connecting a proximal end of the specimen support to the base.

14. The elongated, planar blank of claim 13, further including a first cut line extending from a first end of the first hinge to a second end of the first hinge and defining an outline of the specimen support.

15. The elongated, planar blank of claim 14, wherein the specimen support includes a first prong and a second prong wherein margins of the first prong and the second prong define a notch adapted to receive and hold the elongated specimen.

16. The elongated, planar blank of claim 13, further including a second hinge connecting a proximal end of the tab to the base.

17. The elongated, planar blank of claim 16, further including a second cut line extending from a first end of the second hinge to a second end of the second hinge and defining an outline of the tab.

18. The elongated, planar blank of claim 17, further including a rounded relief cut at each end of the first cut line and the second cut line.

19. The elongated, planar blank of claim 11, wherein the base further includes a guide track adapted for guiding the blank onto a tool when erecting the elongated, planar blank into a specimen mount.
